(19) United States
(12) Patent Application Publication
(10) Pub. No.: US 2017/0193620 A1
(43) Pub. Date: Jul. 6, 2017

(54) ASSOCIATE A LEARNER AND LEARNING CONTENT

(71) Applicant: Hewlett-Packard Development Company, L.P, Fort Collins, CO (US)

(72) Inventors: Ehud CHATOW, Palo Alto, CA (US); Georgia KOUTRIKA, Palo Alto, CA (US)

(21) Appl. No.: 15/315,241

(22) PCT Filed: May 30, 2014
(86) PCT No.: PCT/US2014/040343

§ 371 Date: Nov. 30, 2016

(51) Int. Cl. G06Q 50/20; G09B 7/00; G09B 5/06

(52) U.S. Cl. CPC G06Q 50/20; G09B 5/06; G09B 7/00; G06Q 10/06

(57) ABSTRACT

Examples disclosed herein relate to associating a learner and learning content. A processor determines a learning type cluster based on clustering of learning content attributes and learner attributes based on historical pairings of content and learners and information about outcomes of the pairings. The processor may associate a piece of learning content and a learner based on the learning type clusters and output information about the association.

### BACKGROUND

Students in a classroom setting typically use the same textbook or set of textbooks for the entire class of students. However, particular types of learning content may be more suitable for particular types of students. For example, different students may have different learning styles such that they learn better from particular types of content, such as where a student is better suited to visual or auditory learning content.

### BRIEF DESCRIPTION OF THE DRAWINGS

The drawings describe example embodiments. The following detailed description references the drawings, wherein:

FIG. 1 is a block diagram illustrating one example of a computing system to create associate a learner and learning content based on automatically determined learning types.

FIG. 2 is a diagram illustrating one example of a low chart to create a model of learning types and combining learning content with learners based on the model.

FIG. 3A is a diagram illustrating one example of an automatically generated learning content profile.

FIG. 3B is a diagram illustrating one example of an automatically generated learner profile.

FIG. 4 is a flow chart illustrating one example of a method to associate a learner and learning content based on automatically determined learning type.

FIG. 5 is a flow chart illustrating one example of a method to determine learning types based on historical combinations of learners and learning content.

### DETAILED DESCRIPTION

In one implementation, a processor associates learning content with a learner based on a multidimensional comparison of a learner to a piece of content according to a weight for the learning type associated with the learner and a weight for the learning type associated with the content. The processor may automatically determine learning types for associating learners with learner content based on clustering of content attributes and learner attributes according to historical combinations of content and learners and information about outcomes of the combinations. For example, the processor may determine learning type information related to learners and learning content without using pre-existing learning type classifications. A learning type cluster may indicate that a set of learners and a set of content resulted in similar outcomes, and the attributes of the learners and content in the cluster may be analyzed to extract attributes associated with the particular type of cluster.

A piece of content may be compared to a learning type and weights determined to indicate the degree to which the piece of content matches the profile for the learning type. Similarly, the processor may weight a learner to different learning types where each weight indicates the degree to which the learner attributes match the particular learning type. The attributes of the content and learners may be automatically determined. For example, unstructured content that is, not previously tagged as educational content may be automatically tagged by a processor to indicate attributes such as topic and format. For example, the processor may analyze metadata associated with the content as well as the content itself.

The comparison may involve a multidimensional analysis that takes into account the association of individual attributes with a learning type to allow for a more granular approach. For example, a learner may have multiple attributes, and the processor may create a learner profile and determine the degree to which the individual attributes are associated with each of a group of learning types. A piece of learning content may have multiple attributes, and the processor may create a learning content profile and determine the degree to which the individual attributes are associated with each of the learning styles in the group. As an example, a learner based on an gender attribute may have learning style verbal association 0.7 and learning style mathematical association 0.3, but based on age, the learner may have learning style verbal association 0.5 and learning style mathematical association 0.5.

People may have different learning styles and learn better from particular types of content, such as audio or visual content. A learner may have a degree of different learning styles as opposed to a single dominant learning preference. In addition, learning content may appeal to multiple learning styles to multiple degrees, such as where a webpage includes both text and a video. A system for associating content with a learner may be desirable for formal education, job training, and informal learning, particularly as learning content comes from sources outside of a traditional textbook.

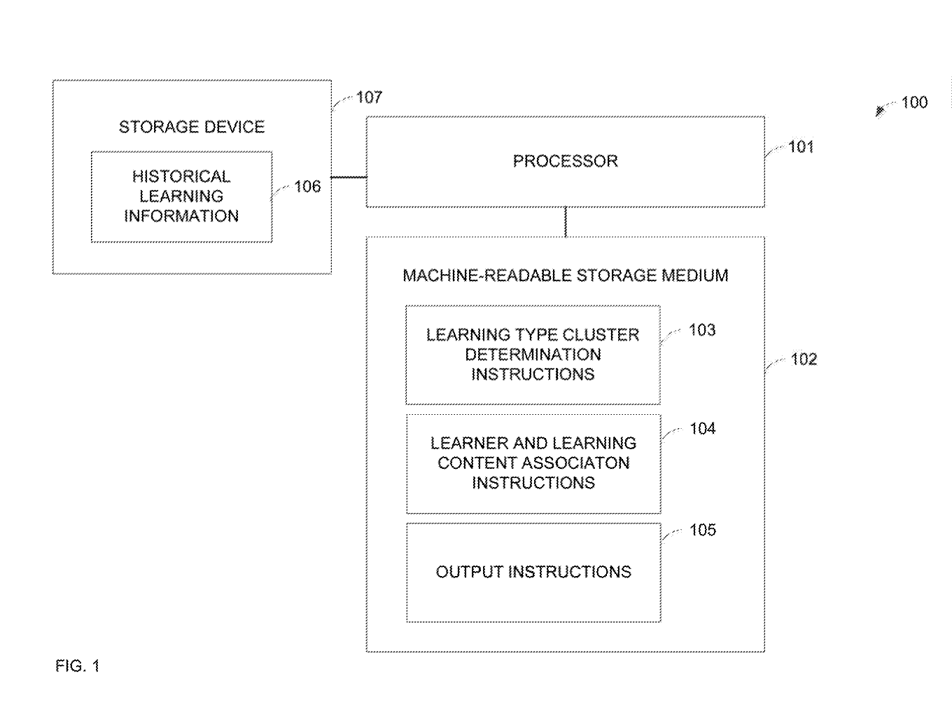

FIG. 1 is a block diagram illustrating one example of a computing system to associate a learner and learning content based on automatically determined learning types. The computing system 100 may be used to determine learning material suited to a particular learner or group of learners. The computing system 100 may use a multivariate model for matching the learning content and learner based on the type of learning. For example, a processor may analyze historical learner and learning content combinations to determine a set of learning types and learner and learning content attributes associated with the learning types. The learning content may be automatically associated with weighted categories based on a set of learning types, such as where the learning content is 0.3 verbal learning and 0.8 for auditory learning. The computing system 100 may include a storage device 107, a processor 101, and a machine-readable storage medium 102.

The processor 101 may retrieve information from the storage device 107. The storage device 107 may be a personal computing device. The storage device 107 includes historical learning information 106. The historical learning information 106 may include information about previous combinations of learning content and learners and information about the learning outcomes of the combinations. For example, the learning outcome may be measured by a learner or teacher response to a survey and/or a learner assessment score based on the learner content.

The processor 101 may be a central processing unit (CPU), a semiconductor-based microprocessor, or any other device suitable, for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include learning type cluster determination instructions 103, learner and content association instructions, and output instructions 105.

The learning type cluster determination instructions 103 may include instructions to cluster learning types based on the historical learning information 107, For example, combinations with similar outcomes may be clustered together and common attributes of the learners and common, attributes of the learning content in the clusters may be extracted. Learner and/or learning content profiles may be created based on the extracted attributes and the degree to which the learner and/or learning content exhibit the attributes.

The learner and learning content association instructions 104 may include instructions to associate learners and learning content. For example, a learner profile and a learning content profile may be compared to a learning type. The degree to which the learner profile matches the learning type may be compared to the degree to which the learning content matches the learning type. In cases where both the learner and learning content match the profile, the learning content and the learner may be associated with one another.

The output instructions 105 may include information about the association of the learning content and learner. For example, the content may be stored to be combined with other material to create a printed or digital book. The content may be emailed to the student and/or displayed to the student.

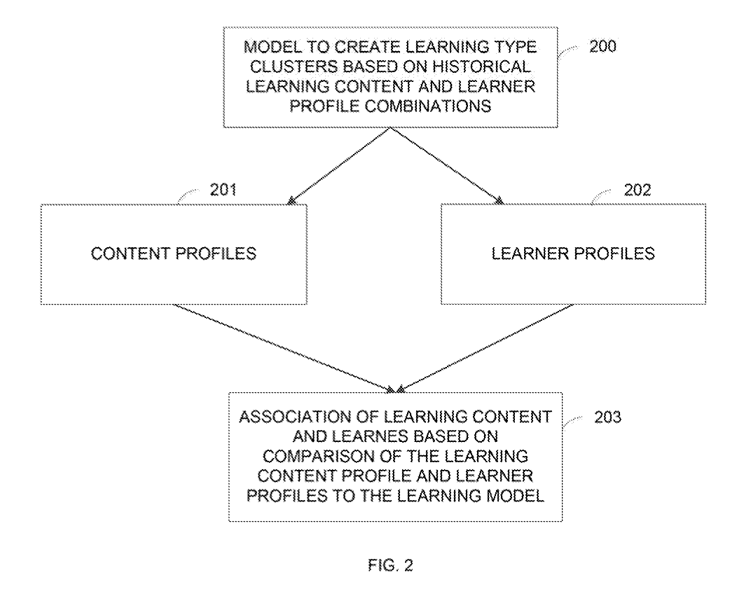

FIG. 2 is a diagram illustrating one example of a flow chart to create a model of learning types and combining learning content with learners based on the model. Block 200 shows a model to create learning type dusters based on historical learner and learning content combinations. The model may include, for example, learning types A, B, . . . G where learning type A has learning content attributes verbal and auditory and learning type G has learning content attribute naturalistic. Historical data related to learner and user combinations may be analyzed to associate clusters of learner attributes and content attributes that result in higher performance, such as where learner attribute 1 and learning content attribute 20 are likely to result in high performance and where learner attribute 2 and learning content attributes 5 and 6 are likely to result in high performance.

Block 201 shows learning content profiles created from the learning type model in block 200. The learning content profile may match the learning content up with learning types and assign a weight to each learning type indicating how closely the learning content matches the particular learning type attributes.

Block 202 shows learner profiles created from the learning type model in block 200. For example, a learner may be compared to a learning type and weighted to indicate the degree to which the learner is associated with attributes of the learning type.

Block 203 shows associating learning content and learner combinations based on the learning content and learner profiles. For example, a processor may rank combinations where the learner and content have higher weights for the same learning type.

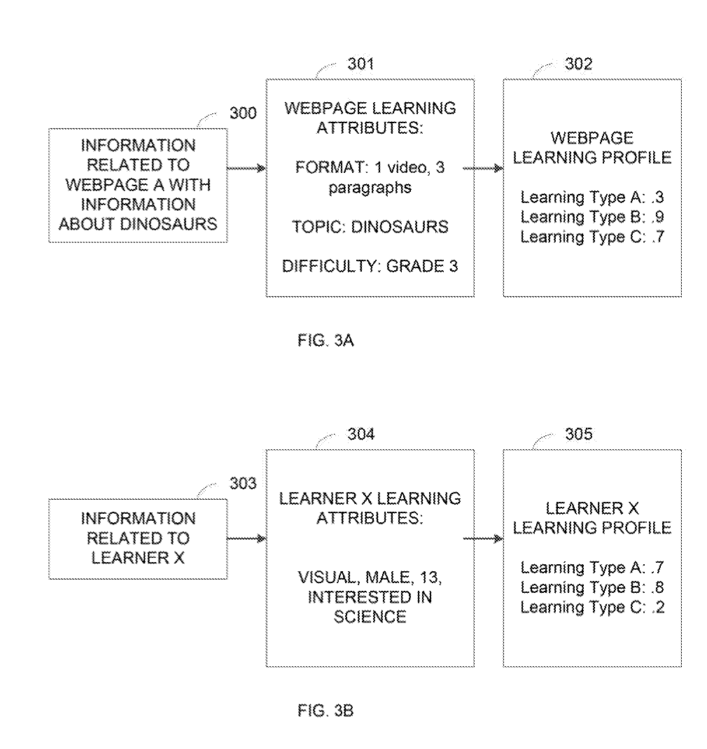

FIG. 3A is a diagram illustrating one example of an automatically generated learning content profile. Block 300 shows a webpage with learning content about dinosaurs. A processor extracts attributes related to the webpage, such as based on the metadata of the webpage. Block 301 shows format, topic, and difficulty level attributes associated with the learning content. Block 302 shows a learning profile for the learning content indicating the degree to which the learning content on the webpage matches the 3 learning types.

FIG. 38 is a diagram illustrating one example of an automatically generated learner profile. Block 303 shows information about a learner X. At block 304, the learner information is analyzed. At block 304, a processor determines learner attributes based on the learner information. At block 305, a processor determines a learner profile based on the learning attributes and how they compare with learning types. For example, learner X is most aligned with learning type 2.

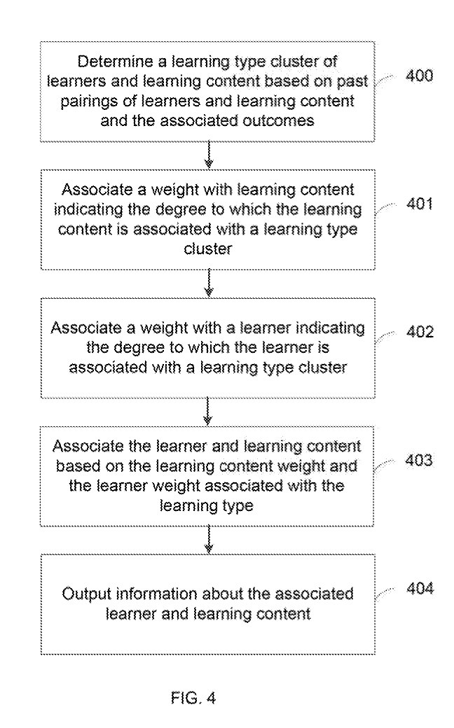

FIG. 4 is a flow chart illustrating one example of a method to associate a learner and learning content based on automatically determined learning type. For example, a processor may automatically select learning content to associate with a learner. The learning content may be unstructured web content. For example, content that may not otherwise be tagged as learning content may be searched, tagged, and ranked for a particular learner or type of learner. A multi-dimensional analysis may be performed to take into account a comparison of the learning content and learners to historical combinations and outcomes to determine a selection and/or ranking of learning content to learners for future learning. The method may implemented, for example, by the computing system 100 of FIG. 1.

Beginning at 400, a processor determines a learning type cluster of learners and content based on past pairings of learners and learning content and, the associated outcomes. The learning content may be, web content, documents, or other content. The learning content may or may not be specifically identified as learning content. The learning content may be a piece of content as a whole or a particular section of the learning content, such as a chapter or exercise. The learner may be any person to receive information, such as for informal training, job related training, and/or formal education. The learning content attributes may be determined, for example, by analyzing text, video, or other media associated with the learning content as well as analyzing metadata. The learner attributes may be determined based on surveys or other user provided data. In some cases, learner attributes may be further refined based on learner performance.

The learning type clusters may be determined based on historical combinations of learners and learning content and associated outcomes. The outcomes may be determined based on learner feedback, teacher feedback, objective assessments, or learner scores, such as grades. In one implementation, the feedback is related to physical data related to the learner, such as eye contact, heart rate, or other information indicating the interest of the learner. For example, the processor or another processor may collect and interpret data relevant to a user's experience with the learning content. The processor creates clusters of previous combinations such that each cluster includes combinations with similar performance levels. The processor may then determine attributes associated with the cluster. In some cases, the attributes may be weighted, such as where a cluster is considered to be relevant to 0.5 visual learning and 0.2 auditory learning. The learning profile may be based on the type of content, such as where different attributes are identified and different learning type clusters associated for video content than for documents. Any suitable clustering method may be used. Any suitable clustering method may be used. The final clusters may comprise the learning types. In one implementation, the processor trains classifiers for each learning type cluster to build models that represent the learning type clusters such that the classifier models become the learning types. For example, a classifier model, such as a decision tree, may be used to generate a model to determine the learning type clusters

In one implementation, the learning type information is displayed such that a user may associate a semantic label with a learning type. The semantic label may be used for user input to manually tag a learner or learning content with the learning type. In one implementation, learning types are automatically determined, and information about the learning types is displayed to a user to allow the user to filter the determined learning types, such as to remove some of the learning types that a teacher does not want to use to associate learners and learning content.

Proceeding to 401, a processor associates a weight with learning content indicating the, degree to which the learning content is associated with a learning type cluster. For example, some of the attributes of the learning content may be associated with the learning type and some not. In some cases, the learning content is associated with a learning type where the degree of association is above a threshold. The learning content may be compared to a subset of learning clusters, such as where the potential clusters are selected according to other criteria. The learning attributes may include, for example, media type (ex. audio, visual), function (ex. chapter, quiz, exercise), presentation (ex. resolution size), difficulty level (ex. introductory, advanced), and specificity level (ex. broad, focused, specialized). A learning content profile may be created where a vector includes a weight for each learning type indicating the degree to which the learning content is associated with the particular learning type.

In one implementation, multiple attributes are compared to a learning type to create a single learning profile for a learner or learning content to aggregate how the attributes of the learner or learning content correspond to the learning type. For example, a processor may create an N×M matrix associated with a learner where the rows correspond to learner attributes and the columns correspond to learning types. The processor may first perform some filtering, such as by filtering out some attributes or some learning types. There may be weights for each attribute, such as where a learner X has 0.3 of the verbal learning ability that is associated with learning type A based on his performance and 0.5 of the verbal learning ability associated with learning type A based on his age. As an example, a profile for a piece of learning content and/or a learner may be a matrix representation with columns corresponding to learning types and rows related to attributes of the learning content and/or learner such that the value for the cells indicates the degree to which the particular attribute is associated with the learning type. The processor may aggregate the attribute weights associated with each of the learning types to create a representative weight for each learning type. In one implementation, the processor creates a vector profile from the matrix by aggregating the degree to which the individual attributes are associated with the learning type into an overall degree of association with the learning type. For example, a score may be computed to determine how each attribute matches the learning type, and the scores may be aggregated. In some implementations, the processor ignores some of the attributes when creating the aggregated score, such as where it is desirable to compare learning profiles of particular dimensions. For example, the learning profile may be recreated based on the goals of the particular association and the attributes related to those goals.

Proceeding to 402, a processor associates a weight with a learner indicating the degree to which the learner is associated with a learning type cluster. Attributes related to the learner may be determined, for example, based on surveys, demographics, report card information, and success on objective assessments. The learner attributes and/or learner history may be used to determine the degree to which the learner is associated with a learning type. For example, learner performance on a past exam and learner gender may be used to determine a weight for the degree to which the learner is associated with a particular learning type. For example, the learner may have a 0.8 association with learning type A. In some cases, weights below a threshold are disregarded, such as where a low association with a learning type is not considered when associating a learner with learning content. A learner profile may be, for example, a vector with a weight for each entry where each entry corresponds to a learning type.

In one implementation, the learning profile includes the degree to which individual attributes of the learner are associated with each learning type. For example, the learner learning profile may be an M×N matrix with the rows corresponding to attributes of the learner and the columns corresponding to learning types. The entries may indicate the degree to which the particular attribute corresponds to the particular learning type. In one implementation, the processor aggregates the matrix learning profile into a vector based learning profile by aggregating the individual attribute weights to create a single weight representative of the association of the learner to the learning type.

Proceeding to 403, a processor associates the learner and learning content based on the learning content weight and the learner weight associated with the learning type. A multidimensional analysis may be performed to rank content to associate with a particular learner. For example, a learner profile vector may be compared to a learning content profile vector where the vector entries are related to how the particular learner and learning content are associated with the learning types. Content may be selected based on the ranking, such as selecting the learning content with the top 3 rankings or selecting content with a ranking score above a threshold. In some implementations, pre or post processing may occur. For example, the processor may filter learning types by topic.

The association may involve, for example, ranking a list of learning content compared to a learner or ranking a list of learners compared to a piece of learning content. In one implementation, the processor determines learning content related to the first piece of learning content, such as to make additional recommendations based on the a relationship with selected learning content in addition to or instead of based on a relationship of the additional learning content to the learner. For example, comparing learning content to learning content may be useful where learning content options were provided to a learner, and the learner selected a subset of the options. The processor may then make future recommendations based on learning type analysis of the selected learning content by comparing learning profiles of the selected learning content to learning profiles of other learning content.

The ranking may be performed in any suitable manner. In one implementation, the ranking is performed by first filtering the objects to be ranked, such as where there are additional criteria than the learning types. For example, to rank learning content for a particular learner, the learning content may first be filtered by quizzes. As another example, the learners to associate with the learning content may be filtered by an age attribute.

In one implementation, the association involves comparing a vector associated with a first object where each row is related to a learning type and a vector associated with the target object where each row is related to a learning type. A score may be generated for each row to indicate how the weights of the particular learning type compare, and an aggregate score may be created based on the comparison weights for each of the learning types. The aggregate score of multiple objects may be compared to determine which to associate, such as those above a threshold or the top N.

In one implementation, the processor associates multiple learning objects. For example, the processor may determine a set of learning content for a learner or learning content for a set of learners. For example, the candidate may be compared to the target to get a score for each learning type. The processor may then aggregate the individual scores for the association score. The processor may then compare the aggregate score between the target and the group.

Proceeding to 404, a processor output information about the associated learner and content. For example, the processor may transmit, store, and/or display information about a recommended combination of learning content and learner. The processor may display information about recommended learning content to allow a user to make a selection from the displayed options. The processor may provide selected learning content, such as by emailing it to the learner. In some implementations, multiple pieces of learning content are selected, such as to achieve a balance of learning materials for different learning types that apply to the particular learner. The processor may select an order to present content to a learner, such as selecting introductory content and intermediate content for the same learner. The model may be updated based on feedback, such as based on additional assessments or learner and/or teacher surveys.

The associations of learners and learning content may be performed in a manner to achieve different objectives. For example, learning content may be ranked according to how it is associated with a particular learner, and recommendations may be automatically made for a student or group of students based on the rankings. A set of students may be ranked according to their association with a set of learning content, such as to determine a list of potential students for an advanced class tailored to the set of learning content. In one implementation, the processor further compares learning content profiles to determine related learning content, such as where a piece of learning content is automatically selected for a learner and the selected learning content is used to determine further recommendations in addition to comparing the learner learning type information to additional learning content.

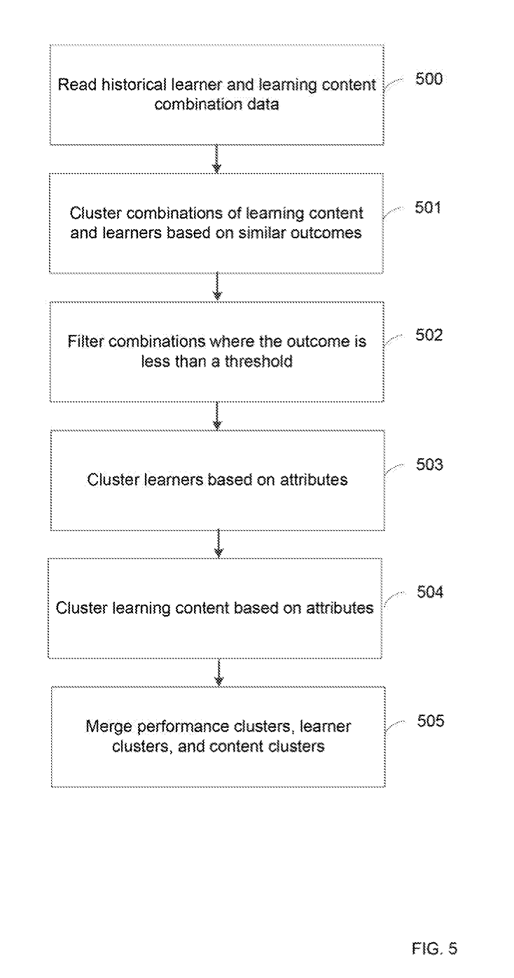

FIG. 5 is a flow chart illustrating one example of a method to determine learning types based on historical combinations of learners and learning content. For example, a processor may perform a multi-dimensional multi-phase cluster method to determine learning types. For example, the clustering to determine the learning types may involve separately clustering learners and learning content and then creating a learning type cluster based on the two separate clustering methods. The process may run in a batch or incremental mode, such as where newly received historical combinations are added to the clustering methods. The method may be performed, for example, by the computing system 100.

Beginning at 500, a processor reads historical learner and learning content combination data. For example, the processor may receive data from a database. The data may include a grade related to the outcome of the combination, such as a user score on an assessment or a representation of a qualitative score from a survey indicating the success of the combination. Outcome information may include, for example, learning survey ratings, student performance data, teach assessment information, student/teacher interview information, and/or discussion forum information. The information may come from different sources, such as from a survey to a learner or teacher or social forums. In one implementation, questionnaires related to the outcome may include questions populated based on the particular learner attributes and a pre-defined template. An objective assessment to test the outcome may be tailored to the particular learning attributes of the learner.

Proceeding to 501, a processor clusters combinations of learning content and learners based on similar outcomes. For example, there may be a threshold such that a cluster contains combinations where the difference in the outcome score is less than the threshold.

Proceeding to 502, a processor filters combinations where the outcome is less than a threshold. For example, combinations that were not successful may be removed from the model.

Proceeding to 503, a processor clusters learners based on attributes. For example, the learners may be clustered based on attributes, such as gender, overall performance, and major.

Proceeding to 504, clusters learning content based on attributes. For example, the learning content may be clustered based on attributes, such as topic and format.

Proceeding to 505, a processor merges performance clusters, learner clusters, and content clusters. For example, if two learners belong to the same user attribute based cluster and/or two pieces of learning content belong to the same learning content attribute based cluster, the two combinations are merged in the performance based cluster if the performance for the cluster remains within an acceptable range, e.g., all students had a performance above a threshold. The merging may be performed in an iterative manner. In one implementation, the merged clusters are used as the learning type dusters, such as where the attributes of the objects within the clusters are extracted and used to determine membership for future combinations in the cluster. In one implementation, a classifier is trained on each cluster, and the classifier models are used as the learning type models. Using dynamically determined learning types that may be applied to unstructured learning content allows for better identification of learning content for learners that is tailored to achieve better outcomes for the learner.

1. A computing system, comprising:
a storage to store historical learning information, wherein the historical learning information includes learner attribute information and learning content attribute information and previous result information associated with combinations of learners and learning content; and
a processor to:
determine learning type clusters based on associations between learn attribute information and learning content attribute information based on the historical learning information;
associating a learner with the learning content based on a comparison of the degree to which a piece of learning content is associated with a learning type cluster and the degree to which a learner is associated with the learning type cluster; and
outputting information about the associated between the learning content and learner.

2. The computing system of claim 1, wherein the processor determines the content type of the piece of content and determines the learning content attribute information based on the type of content.

3. The computing system of claim 1, wherein the processor further selects a position to order the associated learner content among other learning content associated with the learner.

4. The computing system of claim 1, wherein associating a learner with learning content comprises comparing a learner learning profile associated with the learner to a learning content learning profile associated with the learning content,
wherein the learner learning profile includes attributes associated with the learner and the degree to which the individual learner attributes are associated with the learning type, and
wherein the learning content learning profile includes attributes associated with the learning content and the degree to which the individual learning content attributes are associated with the learning type.

5. The computing system of claim 1, wherein the processor is further to associate the learning content with a second piece of learning content based on the degree to which the learning content is associated with the learning type and the degree to which the second piece of learning content is associated with the learning type.

6. A method, comprising:
determining a learning type cluster of learners and learning content based on past combinations of learners and learning content and the associated outcomes,
wherein the learning type clusters include attributes based on the attributes of the learners and attributes of the learning content within the learning type cluster;
associating a weight with learning content indicating the degree o which the learning content is associated with a learning type cluster;
associating a weight with a learner indicating the degree to which the learner is associated with the learning type cluster;
associating the learner and learning content based on the learning content weight and the learner weight associated with the learning type; and
output information about the associated learner and content.

7. The method of claim 7, wherein determining learning type clusters comprises determining clusters based on similar outcomes.

8. The method of claim 7, wherein determining learning type clusters comprise disregarding a learner and teaming type combination when determining a learning type cluster where the outcome associated with the combination is less than a threshold.

9. The method of claim 7, wherein associating the learner and learning content comprises a a comparison based on learner attributes of the learner and the association of the learner attributes with the learning type and learning content attributes of the learning content and the association of the learning content attributes with the learning content.

10. The method of claim 7, further comprising, updating the learning type clusters based on feedback related to new learner and learning content combinations.

11. The method of claim 7, further comprising associating a semantic label with a learning type cluster.

12. The method of claim 7, further comprising associating a second piece of learning content with the learning content based on the learning type.

13. A machine-readable non-transitory storage medium comprising instructions executable by a processor to:
determine learning type clusters based on clustering of learning content, attributes and learner attributes based on historical pairings of content and learners and information about outcomes of the pairings:
score a relationship between the learning content for a learner based on a multidimensional comparison of a learner to a piece of learning content according to learning type associations with the learner and learning type associations with the piece of learning content; and
output information about the score.

14. The machine-readable non-transitory storage medium of claim 12, wherein the multidimensional comparison comprises a comparison based on learner attributes of the learner and the association of the learner attributes with the learning type and learning content attributes of the learning content and the association of the learning content attributes with the learning content.

15. The machine-readable non-transitory storage medium of claim 12, where instructions to output information about the score comprise instructions to output at least one of a selection of learners associated with learning content and output recommended learning content to a learner.
